(19) United States
(12) Patent Application Publication
(10) Pub. No.: US 2015/0024720 A1
(43) Pub. Date: Jan. 22, 2015

(54) Remote Testing Through Third Party Devices

(71) Applicant: VONAGE NETWORK LLC, Holmdel, NJ (US)

(72) Inventors: TZAHI EFRATI, HOBOKEN, NJ (US); BOAZ ZEHAVI, JERSEY CITY, NJ (US)

(73) Assignee: VONAGE NETWORK LLC, Holmdel, NJ (US)

(21) Appl. No.: 13/947,555

(22) Filed: Jul. 22, 2013

(51) Int. Cl. H04W 24/00; H04W 12/02; H04W 8/18

(52) U.S. Cl. CPC H04W 24/00; H04W 8/18; H04W 12/02
USPC 455/414.1

(57) ABSTRACT

A method and system for identifying end-user devices for remote testing are provided herein. In some embodiments, a method for identifying end-user devices for remote testing may receiving end-user device profiles from a plurality of end-user devices, receiving a testing plan including device characteristics, comparing the end-user device profiles and testing plan received to produce comparison results, and providing a list of end-user devices and an indication of the comparison results to the remote testing entity.

### BACKGROUND

1. Field

Embodiments of the present invention are related to the field of computing devices and services and, more specifically, directed to a method and system for remote testing through third party devices.

2. Description of the Related Art

Software application developers (e.g., app developers) today deal with heavy fragmentation across various operating system architectures. There are hundreds of different devices in the market today, and each comes with its own feature set, i.e., drivers, screen resolution, volume controls, voice parameters, camera resolution, gain, and the like. In addition, devices might have different behaviors in different countries and/or as deployed by different carriers. Thus, app developers frequently have to test their apps against a large number of devices.

Existing device testing services available include testing entities that provide access to various device models kept in their facilities. However, test services from these testing entities can be expensive and may lack the type of service or feature coverage desired to be tested. For example, a testing entity might have many devices from certain carriers in West Europe, but very poor device inventory from carriers in the Middle East. In addition, the devices are physically located in a lab in a fixed physical location. This does not provide a good testing environment for certain types of mobility features such as roaming and network coverage. In addition, device being tested are typically “sterile.” That is, they are usually cleaned and formatted whenever a new testing customer starts using them so they do not represent a “real world” device as would be used and personalized by actual telephony service subscribers, for example. Therefore, although existing testing platforms for testing devices may exist, they have issues with cost, versatility of devices and user types, coverage of countries, carriers, devices, operating system versions, and time of testing.

Thus, there is a need for a way to obtain ready and efficient access for testing to a large number of devices that exist in real-world conditions.

### SUMMARY

A method and system for registering an end-user device with a testing service for remote testing of the end-user device are provided herein. In some embodiments, a method for registering an end-user device with a testing service for remote testing of the end-user device may include retrieving privacy policy settings set by a user associated with the end-user device, collecting information about the end-user device based on the privacy policy settings, creating an end-user device profile including the collected information and the privacy policy settings set by the user, and sending the end-user device profile to a testing service to register the end-user device with the testing service.

In some embodiments, a method for remotely testing an end-user device may include receiving a request from a remote testing entity via a testing service to perform testing of the end-user device, providing access to the remote testing entity to perform the requested testing on the end-user device based on privacy policy settings set by a user associated with the end-user device, and sending test results to the testing service based on the tests performed.

In some embodiments, a method for identifying end-user devices for remote testing may receiving a plurality of end-user device profiles including information associated with a plurality of end-user devices, receiving a testing plan including device characteristics, comparing the plurality of end-user device profiles and received testing plan, and providing a list of end-user devices to the remote testing entity indicative of one or more matches between the testing plan and the plurality of end-user device profiles.

Other and further embodiments of the present invention are described below.

### BRIEF DESCRIPTION OF THE DRAWINGS

So that the manner in which the above recited features of embodiments the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system for remote testing through third party devices, in accordance with embodiments consistent with the present application;

FIG. 2 depicts a block diagram of a end-user device, in accordance with embodiments consistent with the present application;

FIG. 3 depicts a flow diagram of a method of registering an end-user device with a testing service for remote testing of the end-user device, in accordance with embodiments consistent with the present application;

FIG. 4A depicts a flow diagram of a method for identifying end-user devices for remote testing, in accordance with embodiments consistent with the present application;

FIG. 4B depicts a flow diagram of a method of selecting and testing end-user devices for remote testing, in accordance with embodiments consistent with the present application;

FIG. 5 depicts a flow diagram of a method of remotely testing an end-user device, in accordance with embodiments consistent with the present application;

FIG. 6 is a detailed block diagram of a computer system, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention are directed to methods and systems for remote testing of third party devices. In some embodiments, resources available on devices of device owners are matched to the testing needs of developers or entities requesting testing services. Thus, exemplary embodiments provide access to testing of a large number of devices that exist in real-world conditions, and used and personalized by actual telephony, or other service, subscribers. That is, embodiments of the present invention crowd source the testing of apps/devices.

In some embodiments, the matching may take place through an intermediary testing service, e.g. a test control service (TCS). The test control service (TCS) is communicatively coupled to at least one user device, accessible by one or more developers, or remote testing entities, that are interested in testing their applications and services on user devices. In some embodiments, device owners who register with the TCS and make their device available for testing may be compensated by the TCS for the amount of time their phone was used, and/or for the access to various features of the device (e.g., monetarily, in free or discounted telephony service, and the like). The developers and entities requesting testing may lease/compensate the testing service provider for devices tested. Examples of features that may be tested include any device functionality. A remote testing entity may have as much access to the device as allowed by the device owner through privacy policy settings. Thus, the access may be from full unrestricted access to very specific features that are allowed to be accessed and times that the device may be tested.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

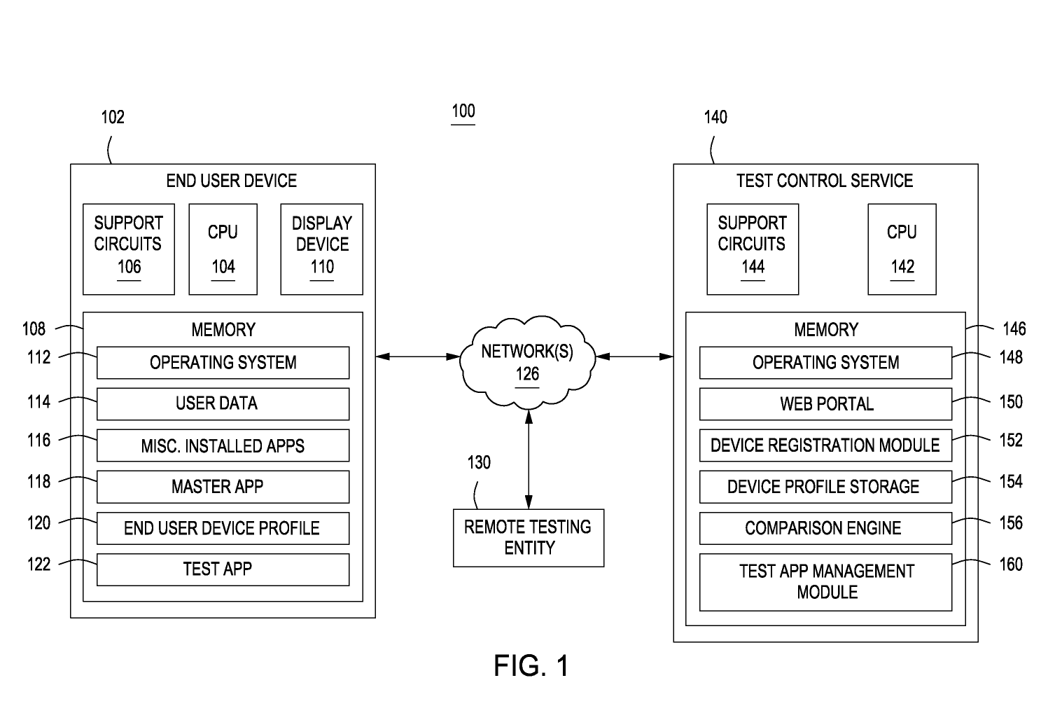

FIG. 1 depicts a block diagram of a system 100 that includes an end-user device 102 owned and used by a subscriber (also referred to herein as an end-user or device owner) to a telephony (or other type) of service, a test control service 140, and a remote testing entity 130 communicating over one or more networks 126, according to one or more embodiments.

The end-user device 102 comprises a Central Processing Unit (CPU) 104, support circuits 106, memory 108, and the display device 110. The CPU 104 may comprise one or more commercially available microprocessors or microcontrollers that facilitate data processing and storage. The various support circuits 106 facilitate the operation of the CPU 104 and include one or more clock circuits, power supplies, cache, input/output circuits, and the like. The memory 108 comprises at least one of Read Only Memory (ROM), Random Access Memory (RAM), disk drive storage, optical storage, removable storage and/or the like. In some embodiments, the memory 108 comprises an operating system 112, user data 114, miscellaneous installed apps 116, a master app 118 for testing, an end-user device profile 120, and one or more test apps/scripts 122.

The operating system (OS) 112 generally manages various computer resources (e.g., network resources, file processors, and/or the like). The operating system 112 is configured to execute operations on one or more hardware and/or software modules, such as Network Interface Cards (NICs), hard disks, virtualization layers, firewalls and/or the like. Examples of the operating system 112 may include, but are not limited to, various versions of LINUX, MAC OSX, BSD, UNIX, MICROSOFT WINDOWS, 10S, ANDROID and the like.

The user data 114 may include an end-user's personal data such as their contacts, images, calendar data, music, and the like. Miscellaneous installed apps 116 are apps that have been installed on the end-user device by the end-user.

The master app 118 is a testing control and monitoring application made available to the end-user by the test control service 140 and is described below in more detail. In some embodiments, an end-user may download the master app 118 from the test control service 140, or from an app distribution system associated with the test control service 140, and install the master app 118 on their device. Although the master app 118 is described herein as a separate stand-alone application, in some embodiments the master app 118 may be integrated into OS 112, and may use existing application programming interface (API) calls provided by the OS 112 to access or control various features of the end-user device 102.

In some embodiments, the master app 118 may be used to create an end-user device profile 120 that includes end-user device information and privacy policy settings set by the user associated with the end-user device 102. The information included in the end-user device profile 120 may be used to control the amount and type of testing to be done on the end-user device 102. For example, in some embodiments, the privacy policy settings provide, or otherwise define, access to user data 114 (such as, user contact information, calendar information, images), as well as hours of availability for testing, service features that may be tested and/or usage restrictions. Providing or defining access to the user data 114 may include defining levels of access to specific types of user data. For example, privacy policy settings may provide that a test app may only access the number of contacts included on end user device 102 but not specific information about the contacts. In some embodiments, the end-user device information included in the end-user device profile 120 may include apps installed on the device, number of contacts, type of telephony service available, end-user device model, service provider, phone number and/or geolocation information.

Test app 122 may include an actual application (such as a mobile app) to be tested on the device, or test scripts that may be executed on the end-user device 102 to test various features and/or services. In some embodiments, the test app 122 may be downloaded to the end-user device 102 from test control service 140 automatically by the master app 118, or manually by the end-user. In other embodiments, the end-user or master app 118 may download the test app 122 directly from remote testing entity 130. In still other embodiments, test app 122 may be sent to the end-user device by either the remote testing entity 130 or the test control service 140.

The networks 126 comprise one or more communication systems that connect computers by wire, cable, fiber optic and/or wireless link facilitated by various types of well-known network elements, such as hubs, switches, routers, and the like. The networks 126 may include an Internet Protocol (IP) network, a public switched telephone network (PSTN), or other mobile communication networks, and may employ various well-known protocols to communicate information amongst the network resources.

The remote testing entity 130 may be an application developer or a service provider that wants to test their applications/services and real world devices. When a remote testing entity 130 needs to test an application or roll out a new service, the remote testing entity 130 may determine the types of devices and services they want to test. The remote testing entity 130 may interact with the test control service 140 via networks 126. The remote testing entity 130 may create or select testing plans to execute. Each testing plan may include the types of tests to be run and the devices, OS types and versions, carriers, countries, subscription models, etc., to test. In some embodiments, the testing plans may also include accessibility requirements such as access to contacts, images, location, calls and data usage as defined by the end-user privacy profile included in end-user device profile 120.

The test control service 140 comprises CPU 142, support circuits 144, and memory 146. The memory 146 comprises at least one of Read Only Memory (ROM), Random Access Memory (RAM), disk drive storage, optical storage, removable storage and/or the like. In some embodiments, the memory 146 may include an operating system 148, web portal 150, an end-user device registration module 152, end-user device profile storage 154, comparison engine 156, and test app management module 160. The test control service 140 may be implemented as one or more computer systems communicatively coupled to each other on a network. Each of the one or more computers of the test control service 140 may include one or more of the features described above. The web portal 150 provides the remote testing entity 130 and owners of end-user devices 102 access to the test control service 140. In some embodiments, the web portal 150 may be operated by an external web hosting company.

The test control service 140 presents the remote testing entity 130 with availability of matching devices. That is, after the test control service 140 receives a testing plan from the remote testing entity 130, the test control service 140 will determine a number of devices that may match at least a portion of the testing plan requirements/information. In some embodiments, the test control service 140 may score and/or rank each of the end-user devices determined based on the end-user device profile 120 and testing plan received. The remote testing entity 130 may select one or more of those end-user devices and a time window for the testing. The remote testing entity 130 may upload one or more testing applications/scripts to the test control service 140 for automatic testing of the end-user devices selected. In some embodiments, the remote testing entity 130 may be granted direct access to the end-user devices selected for direct manual testing. In some embodiments, the remote testing entity 130 may test each of the matching devices sequentially. In other embodiments, test app 122 may be sent to the end-user devices 102, either directly or via test control service 140, where the execution of said test app 122 is managed by the master app 118 on each device.

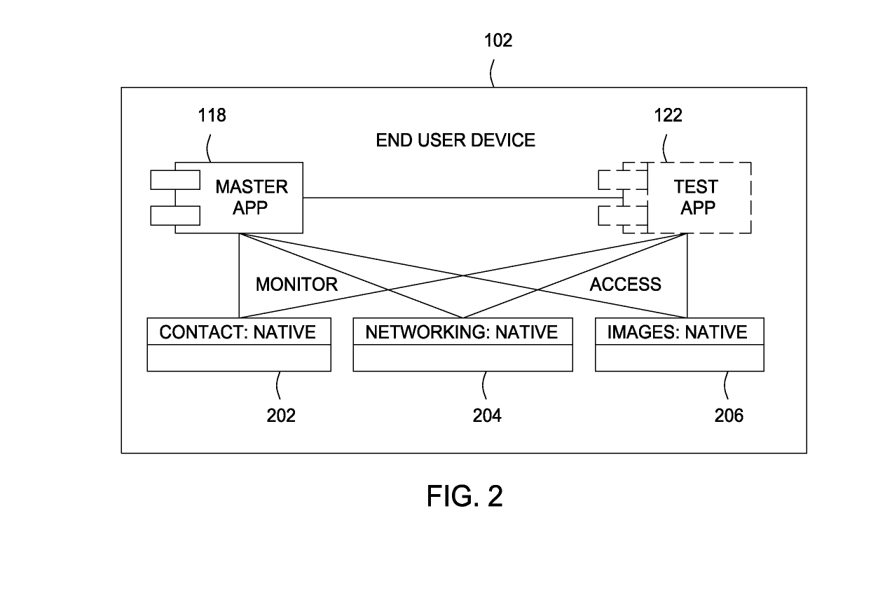

As shown in FIG. 2, the master app 118 may monitor and control the test app 122 being executed. The master app 118 ensures that the end-user privacy policy restrictions are met and the device is not being used inappropriately and according to the defined privacy policy. That is, in some embodiments, test app 122 may request access, or attempt to access, an end-user's contacts 202, networking services 204, and images 206, for example. Master app 118 will limit access to the end-user's contacts 202, networking services 204, and images 206 as defined by the user in the privacy policy set by the user in the end-user device profile 120. The master app 118 may install “hooks” in several places along the path of a request from the app to the OS 112 to monitor usage of the phone and make sure the remote testing entity 130 is conforming to privacy and accessibility restrictions set by the end-user (e.g., such as making calls, connecting to a data network, request to access contacts). That is, in some embodiments, the master app 118 can track any attempt to access private information (e.g., images, contact, location, and the like). This can be achieved in several ways. For examples, the master app 118 may subscribe to receive OS notifications that are triggered whenever an attempt is being made to access to the sensitive information. The master app 118 will check the access request and could restrict access if the request is coming from the test app 122 or the remote testing entity 130 and is restricted by the privacy policy settings. Alternatively, the master app 118 may monitor all requests coming from the test app 122 to the OS 112.

In some embodiments, the master app 118 may send snapshots or a real-time video stream of the end-user device 102 to the remote testing entity 130 via the web portal 150 as the test app 122 is executing. In some embodiments, the remote testing entity 130 can interact with the end-user device 102 as if the device in the tester's hands. In some embodiments, testing results of tests executed on the end-user device 102 are sent to the testing control service. The remote testing entity 130 can review the test results via web portal 150. In other embodiments, the testing results are sent directly to the remote testing entity 130 from the end-user device (e.g., via text, email, or other type of data transfer method).

In some embodiments, the master app 118 and/or test app 122 may access device features and functionalities using an application programming interface (API) or the like. The API may be used to execute remote commands on the end-user device 102 received from the remote testing entity 130 or the test control service 140.

In some embodiments, each test app 122 will include a manifest of features and services it is going to access and a manifest of permissions it needs to perform various tests and gather quality assurance information. If a certain permission, service or feature is in violation of device owner's privacy policy restrictions, the test control service 140 and/or master app 118 will reject the test app 122 and its requests, or limit it's functionality to those features, service and permissions it has been granted access to.

In embodiments where the end-user's privacy policy limits access to certain features, services or contact on the end-user device 102, the master app can create, or permit the test app 122 to create or load, virtual data on the device. For example, “fake” contacts or images may be created or loaded by the master app 118, or by the test app 122. The remote testing entity 130 will have access only to this virtual data set.

Examples of the features and services that may be tested include all possible device functionality. For example, the remote testing entity 130 may have full, partial, or no access (per the owner's privacy policy restrictions) to device features including: rendering of images on various device screens, testing performance under certain bandwidth and CPU restrictions, accessing contacts, images and location, running apps in the foreground or background, making calls over different carrier networks as available, and the like.

In some embodiments, the master app 118 will limit testing of the end-user device 102 to times when the end-user device 102 is determined to be idle. Idleness can be determined as, for example, default time of day, using accelerometer data to detect the device is stationary for at a predetermined time period, periods defined by the end-user, and the like.

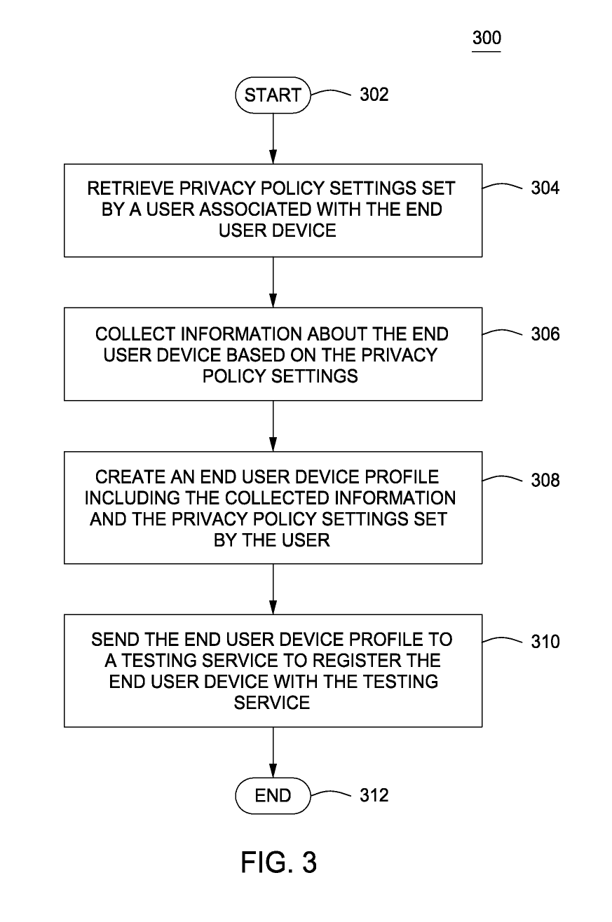

Exemplary methods that may be performed by embodiments of the system described in FIGS. 1 and 2 above, are described below with respect to FIGS. 3-5.

A method 300 in accordance with embodiments of the present invention is illustrated in FIG. 3 which depicts a flowchart having a series of steps for registering an end-user device with a testing service for remote testing of the end-user device. An end-user may choose to register their device with test control service 140 to be used for testing by a remote testing entity 130. In return for allowing their device to be used for testing, the end-user may be compensated (e.g., monetarily, in free or discounted telephony service, and the like.) In some embodiments, the end-user may create an account with test control service 140 and download master app 118 onto their device to control and monitor testing and testing applications. In other embodiments, the end-user may just download the master app 118 from test control service 140, or another app distribution entity. In those embodiments, the act of downloading and installing the master app 118 on the end-user device 102 may initiate the registration process, which is then completed by master app 118.

In detail, the method 300 starts at 302 and proceeds to 304. At 304, privacy policy settings set by the user associated with the end-user device are retrieved from the end-user device. In some embodiments, privacy policy settings are retrieved by the master app 118. The privacy policy settings may be set by the user via selection boxes or other type of selection method. As discussed above, the privacy policy settings define levels of access to user data 114 (such as, user contact information, calendar information, images), as well as hours of availability for testing, service features that may be tested other types of usage restrictions set by the end-user. In some embodiments, the usage restrictions may restrict making calls or SMS (domestic, internationally), restrict data consumption (e.g., can only use 3G data or just Wi-Fi; how much data is the test app 122 allowed to consumer, etc.), or restrict access to read-only access to contacts, or read and write access but no delete permission.

At 306, information about the end-user device 102 is then collected by the master app 118. The amount and type of information collected about the end-user device 102 is based on the privacy policy settings set by the user. The end-user device information may include apps that were installed on device by the user, contact information including the type of and/or number of contacts, the type of telephony service available, the end-user device model or make, the service provider, phone number, geolocation information, OS version, and the like.

The method proceeds to 308, where the master app 118 creates an end-user device profile that includes the privacy policy settings set by the user and collected information about the end-user device 102. In some embodiments, the end-user device profile may be an XML, simple text, delimited file format, proprietary file format, encrypted file, and the like. At 310, the end-user device profile is sent to test control service 140 to register the end-user device 102 with the test control service 140. Once the end-user device 102 is registered with test control service 140, remote testing entities 130 may be able to search for, identify, and select end-user devices 102 that match the criteria that they are interested in testing. The method ends at 312.

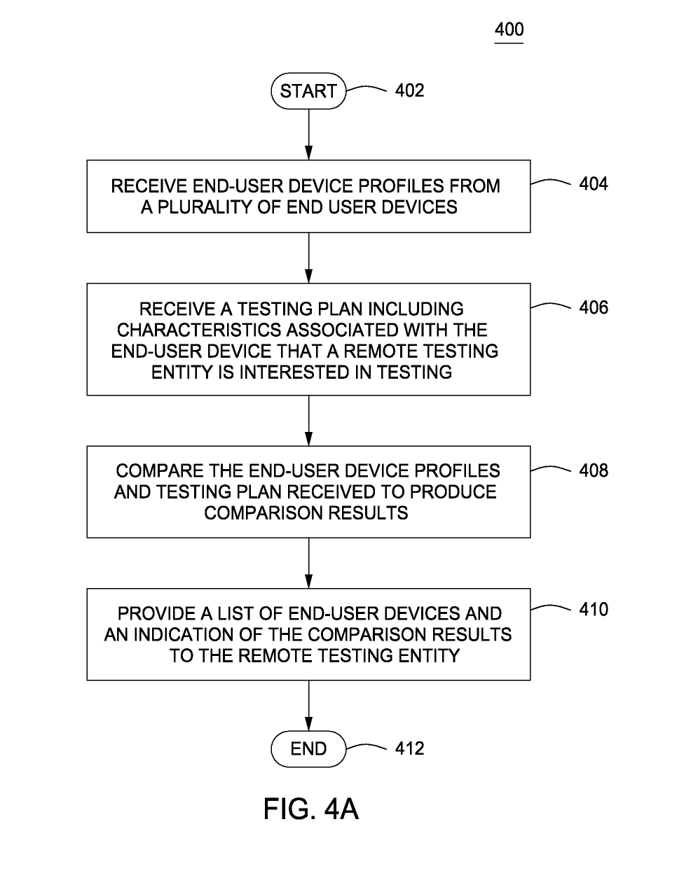

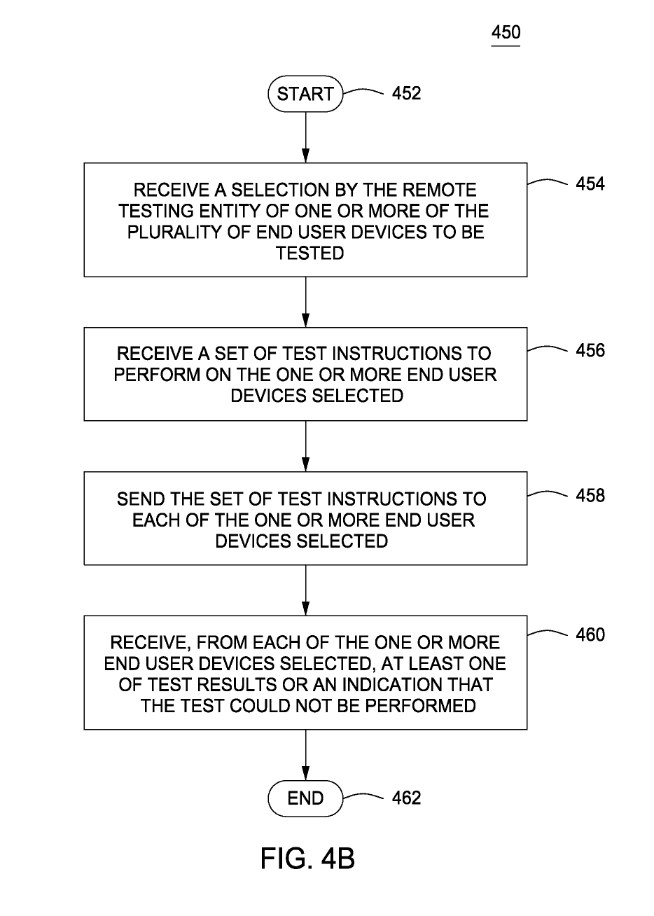

A method 400 in accordance with the subject invention is illustrated in FIG. 4A which depicts a flowchart having a series of steps for identifying end user devices for remote testing. In detail, the method 400 starts at 402 and proceeds to 404. At 404, end-user device profiles are received by the test control service 140 from a plurality of end-user devices 102. The end-user device profiles received may be stored in end-user device profile storage 154. In some embodiments, each end-user device profile includes end-user device information and privacy policy settings set by the user associated with the end-user device. The privacy policy settings may define levels of access to contact information, calendar information, hours of availability, service features that may be tested, and other types of usage restrictions set by the end-user. In some embodiments, the end-user device information may include apps that were installed on device by the user, contact information including the type of and/or number of contacts, the type of telephony service available, the end-user device model or make, the service provider, phone number, geolocation information, and the like.

At 406 testing plan including characteristics associated with the end-user device that the remote testing entity is interested in testing is received. In some embodiments, testing plan is received at the remote testing entity 130. The testing plans may include, for example, testing the look and feel of all Android devices with latest OS; testing video calls quality on old or new devices, old or new CPUs, or old or new network services; testing specific geographical areas, carriers, devices, OS type and version, screen size, CPUs, and the like.

At 408 a comparison of the end-user device profiles and testing plan received is performed. The comparison may be performed by the comparison engine 156 included in test control service 140. In some embodiments, performing the comparison may include determining, for each of the plurality of end-user devices, a test value score based on the end-user device profile and testing plan received. In some embodiments, the test value score indicates an affinity rating, or level of similarity, between the information included in the test plan that the remote testing entity 130 wishes to test and the characteristics of an end-user's device as defined by the end-user device profile. Thus, in some embodiments, the test value score indicates a level of value to the remote testing entity.

At 410 a list of end-user devices is provided to the remote testing entity 130, wherein the list is indicative of one or more matches between the testing plan and the plurality of end-user device profiles. In some embodiments, the list may be a ranked list of the end-user devices (e.g., the top X devices) based on a similarity between the end-user device profiles in the testing plan, the test value scores for each end-user device, and the like. In some embodiments, providing the list to the remote testing entity 130 includes making the list available to the remote testing entity 130 via web portal 150. In some embodiments, the list is ranked by the test value scores. The method 400 ends at 412.

After the list is provided to, or otherwise made available to, the remote testing entity 130, the end-user devices to be tested are selected and tested as shown in method 450 in FIG. 4B. The method 450 begins at 452 and proceeds to 454. At 454, the test control service 140 may receive a selection of one or more of the plurality of end-user devices to be tested. In some embodiments, the selection may be made by the remote testing entity 130 via web portal 150. At 456, a test app 122 to be executed on the end-user devices selected, and/or a set of instructions to perform on the end-user devices selected is received. In some embodiments, the test app and/or the set of test instructions to be performed is included, or a link thereto is included, in the test plan received from the remote testing entity 130. At 458, the test control service 140 may send the test app 122 and/or the set of test instructions to each of the end-user devices 102 selected by the remote testing entity 130. The tests are then performed, or attempted to be performed, on the end-user devices 102 based on the test instructions sent.

At 460, the test control service 140 may receive from each of the end-user devices 102 at least one of (1) test results from the end-user device 102 or (2) an indication that the test cannot be formed on end-user device 102. In some embodiments, the test results received from each end-user device 102 may be sent by the master app 118 or directly from the test app 122. In some embodiments, the testing performed on the end-user device 102 may be an interactive session between the remote testing entity 130 and the end-user device 102. In those embodiments, the test results include the interactive feedback received by the remote testing entity 130 via web portal 150 of the test control service 140. In embodiments where an indication that the test cannot be performed on end-user device 102 is received, the indication may include a reading code or description as to why the test cannot be performed. For example, the indication may state that certain privacy policy setting set by the user would be violated if the tests were performed and therefore access was denied.

In some embodiments, after various tests are performed on end-user device 102, the test control service 140 may compensate an owner of end-user device 102. For example, test control service 140 may credit an account maintained for each end-user registered on test control service 140, and their associated devices, for the amount of time and end-user device was access. The test control service 140 may then be reimbursed by the remote testing entity 130 for the compensation paid to the owner of the end-user device 102 used in the testing. In some embodiments, part or all of the foregoing method may be performed by the test app management module 160. The method 450 ends at 462.

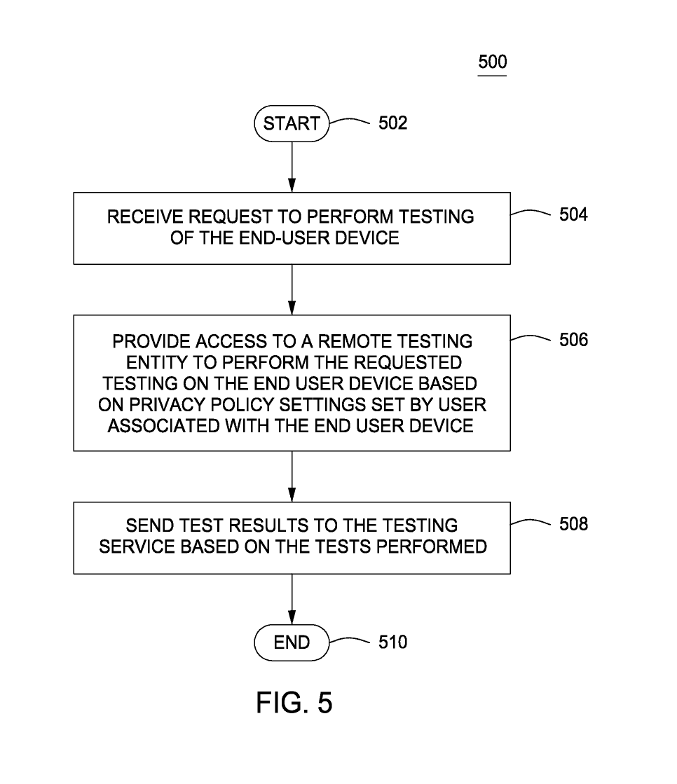

A method 500 in accordance with the subject invention is illustrated in FIG. 5 which depicts a flowchart having a series of steps remotely testing an end-user device. In some embodiments, the method 500 may be performed by master at 118. The method 500 begins at 502 and proceeds to 504. At 504, requests are received by the master app 118 on end-user device 102 to test at least one feature of the end-user device or to run a test app 122 on the end-user device 102. The requests may be initiated by the remote testing at a 130 and sent to the end-user device 102 via test control service 140. At 506, the master app 118 may provide the remote testing entity 130 access to the end-user device 102 to perform the requested testing based on privacy policy settings set by a user associated with the device. At 508 test results were feedback based on the tests were performed are sent back to the test control service 140. The method and at 510.

The embodiments of the present invention may be embodied as methods, apparatus, electronic devices, and/or computer program products. Accordingly, the embodiments of the present invention may be embodied in hardware and/or in software (including firmware, resident software, micro-code, and the like), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java.®, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

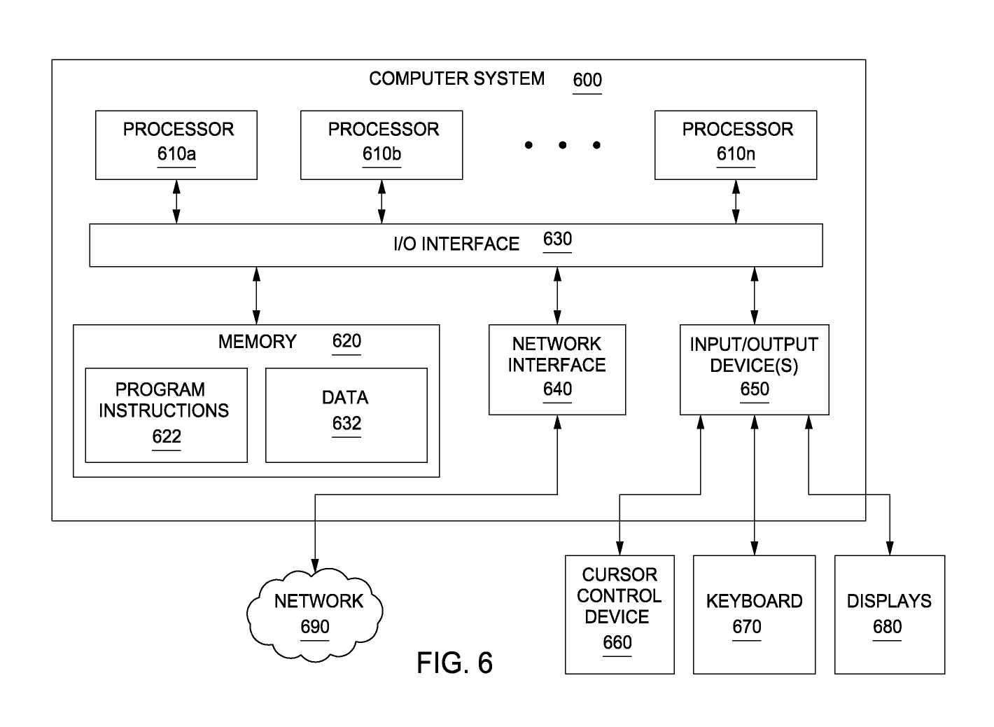

FIG. 6 depicts a computer system 600 that can be utilized in various embodiments of the present invention to implement the computer and/or the display, according to one or more embodiments.

Various embodiments of method and apparatus for transitioning between a plurality of pages on a display device, as described herein, may be executed on one or more computer systems, which may interact with various other devices. One such computer system is computer system 600 illustrated by FIG. 6, which may in various embodiments implement any of the elements or functionality illustrated in FIGS. 1-5. In various embodiments, computer system 600 may be configured to implement methods described above. The computer system 600 may be used to implement any other system, device, element, functionality or method of the above-described embodiments. In the illustrated embodiments, computer system 600 may be configured to implement methods 200 and 300 as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In various embodiments, any of the components may be utilized by the system to receive user input described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the methods illustrated by the flowcharts of FIGS. 2 and 3. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A method for registering an end-user device with a testing service for remote testing of the end-user device, comprising:
retrieving privacy policy settings set by a user associated with the end-user device;
collecting information about the end-user device based on the privacy policy settings;
creating an end-user device profile based upon the collected information and the privacy policy settings set by the user; and
sending the end-user device profile to the testing service.

2. The method of claim 1, wherein the method is performed by an application module installed on the end-user device.

3. The method of claim 1, wherein the privacy policy settings provide at least one of access to contact information access to calendar information, hours of availability, service features that may be tested or usage restrictions.

4. The method of claim 1, wherein the information about the end-user device includes at least one of apps installed on the device, number of contacts, type of telephony service available, operating system type and version, end-user device make and model, service provider, phone number or geolocation information.

5. A method for remotely testing an end-user device, comprising:
receiving a request from a remote testing entity via a testing service to perform testing of the end-user device;
providing access to the remote testing entity to perform the requested testing on the end-user device based on privacy policy settings set by a user associated with the end-user device; and
sending test results to the testing service based on the tests performed.

6. The method of claim 5, wherein the method is performed by an application module installed on the end-user device.

7. The method of claim 5, wherein the privacy policy settings provide at least one of access to contact information, access to calendar information, hours of availability, service features that may be tested or usage restrictions.

8. The method of claim 5, wherein prior to receiving a request to perform testing of the end-user device, the method further comprises:
retrieving the privacy policy settings set by the user;
collecting information about the end-user device based on the privacy policy settings;
creating an end-user device profile based upon the collected information and the privacy policy settings set by the user; and
sending the end-user device profile to the testing service.

9. The method of claim 8, wherein the information about the end-user device includes at least one of apps installed on the device, number of contacts, type of telephony service available, operating system type and version, end-user device make and model, service provider, phone number or geolocation information.

10. The method of claim 5, wherein providing access to test the at least one feature includes sending real-time feedback to a tester requesting the test while the test is being performed.

11. The method of claim 10, wherein the real-time feedback includes at least one of image snapshots from the end-user device, a video stream, display information, or an audio stream.

12. A method for identifying end-user devices for remote testing comprising:
receiving a plurality of end-user device profiles including information associated with a plurality of end-user devices;
receiving a testing plan including device characteristics;
comparing the plurality of end-user device profiles and received testing plan; and
providing a list of end-user devices to the remote testing entity indicative of one or more matches between the testing plan and the plurality of end-user device profiles.

13. The method of claim 12, wherein each end-user device profile includes at least one of end-user device information and privacy policy settings.

14. The method of claim 13, wherein the privacy policy settings provide at least one of access to contact information, access to calendar information, hours of availability, service features that may be tested or usage restrictions.

15. The method of claim 13, wherein the end-user device information includes at least one of apps installed on the device, number of contacts, type of telephony service available, operating system type and version, end-user device make and model, service provider, phone number or geolocation information.

16. The method of claim 12, wherein comparing the end-user device profiles and testing plan received includes determining, for each of the plurality of end-user devices, a test value score based on the end-user device profile and testing plan received.

17. The method of claim 16, wherein the test value score indicates a level of value to the remote testing entity.

18. The method of claim 16, wherein the list of end-user devices is ranked by the test value scores.

19. The method of claim 12, further comprising:
receiving a selection of one or more of the plurality of end-user devices to be tested.

20. The method of claim 19, further comprising:
receiving a set of test instructions to perform on the one or more end-user devices selected;
sending the set of test instructions to each of the one or more end-user devices selected; and
receiving, for each of the one or more end-user devices selected, at least one of test results or an indication that the test could not be performed.

21. The method of claim 20, further comprising:
providing access to the test results to the remote testing entity.

22. The method of claim 19, further comprising:
receiving a set of end-user device features that the remote testing entity will test on the one or more end-user devices selected;
sending a request to each of the one or end-user devices selected to provide access to the set of end-user device features; and
receiving, for each of the one or end-user devices selected, at least one of permission to access the set of end-user device features or an indication that access was denied.
